(19) United States
(12) Patent Application Publication
(10) Pub. No.: US 2024/0167330 A1
(43) Pub. Date: May 23, 2024

(54) QUICK-ACTION DOOR

(71) Applicant: Frinova GmbH, Pansdorf (DE)

(72) Inventor: Wilhelm DÜCK, Lübeck (DE)

(21) Appl. No.: 18/509,437

(22) Filed: Nov. 15, 2023

(30) Foreign Application Priority Data
Nov. 17, 2022 (EP) 22208121.8

(51) Int. Cl. E06B 9/13; E06B 9/17

(52) U.S. Cl. CPC E06B 9/13; E06B 9/17

(57) ABSTRACT

A quick-action door includes a flexible door leaf (12; 14) and a rotatable shaft configuration including at least one rotatable shaft (8), which is configured for the winding-on of the door leaf (12; 14). The door leaf (12; 14) is made from a felt material (32; 36). The felt material (32; 36) is provided with a vapor diffusion-proof coating (34) on at least one surface.

### CROSS REFERENCE TO RELATED APPLICATIONS

This application claims the benefit of priority under 35 U.S.C. § 119 of European Application 22208121.8, filed Nov. 17, 2022, the entire contents of which are incorporated herein by reference.

### TECHNICAL FIELD

The invention relates to a quick-action door.

### BACKGROUND

Quick-action doors are used, for example, on doors in warehouses, in order to be able to open and close them quickly. They take the form of doors with a flexible door leaf, which for purposes of opening is wound onto a shaft. Such a door is of known art, for example, from WO 2016/131476 A1. These types of doors are used, for example, for the closure of cold storage or deep-freeze storage rooms, and must have sufficient insulation properties for this purpose.

### SUMMARY

It is an object of the invention to provide a quick-action door with a flexible door leaf, which has good insulation properties and sufficient flexibility over a wide temperature range for the winding-on procedure.

This object is achieved by means of a quick-action door with the features specified herein. Preferred forms of embodiment ensue from the further features disclosed in the following description, and the accompanying figures.

The quick-action door in accordance with the invention has a flexible door leaf, which is attached to a rotatable shaft configuration, comprising at least one shaft, such that the flexible door leaf can be wound onto the shaft by rotation of the latter. The shaft is connected to a suitable rotary drive, for example an electric motor, and can preferably be driven in both directions of rotation so that the door leaf can be wound on and later unwound again. In the course of the unwinding procedure, the movement of the door leaf can be assisted by gravity, or, if the weight of the door leaf is sufficient, it can also be promoted by gravity alone, at least in sections.

In accordance with the invention, the door leaf is made from a felt material. Felt has good insulation properties, sufficient flexibility for the winding-on procedure, and also good durability. In accordance with the invention, the felt material is provided with a vapor diffusion-proof coating on at least one surface. The vapor diffusion-proof coating prevents moisture from penetrating into the felt material through the surface. Moisture penetration would be problematic, especially when the door is used as one that closes off a deep-freeze storage room, as the moisture could freeze in the felt material, and the felt material would then no longer be sufficiently flexible for the winding-on procedure. Furthermore, the moisture would impair the insulation properties. The vapor diffusion-proof coating is formed on at least one surface, preferably at least on the surface that is facing towards a room with air humidity. When used as a cold storage room door, this is in particular the warm side of the quick-action door.

In a preferred form of embodiment of the invention, the door leaf is provided with a vapor diffusion-proof coating on each of its two surfaces that are facing away from each other. In this manner, moisture penetration is prevented on each side of the felt material. The vapor diffusion-proof coating preferably also has a smooth surface that is easy to clean, and in its appearance, for example its coloring, can be configured in a desirable manner.

The felt material is preferably a felt made from natural and/or artificial fibers. Woolen fibers can, for example, be used as the natural fibers. The felt preferably takes the form of a woolen felt, that is to say, a felt material that is preferably made entirely from natural wool. Such a woolen felt has good insulation properties, can be used over a wide temperature range, and furthermore, as a natural product, has good ecological properties. However, synthetic fibers can also be added to the felt material, or alternatively the felt material could be made entirely from synthetic fibers, depending on the application.

The felt material is preferably configured such that it can be used over a temperature range from −40° C. up to +80° C., furthermore, preferably up to +150° C. Thus, the door leaf is suitable for use in cold storage rooms or deep-freeze storage rooms as well as for applications in which heated rooms are to be closed off, for example rooms for the drying and/or curing of certain products.

In a preferred configuration of the invention, the vapor diffusion-proof coating is made from a plastic material, and furthermore, preferably from a polyurethane material. Such plastic materials have good elasticity and flexibility, which is necessary to allow the door leaf to be wound on. Furthermore, such plastic coatings can easily be applied to the felt material, and can ensure the desired vapor diffusion-proof properties. A polyether-based polyurethane is particularly preferred. Such a material has the desired resistance to cold. However, other materials that exhibit the desired barrier effect against vapor can also be used. These can be suitable plastic materials, or also coatings with a metal content. Multi-layer coatings can also be used.

The vapor diffusion-proof coating is, furthermore, preferably configured such that it is flexible enough to allow the door leaf to be rolled up even at temperatures below 0° C., and furthermore, preferably at temperatures below −20° C. This flexibility and elasticity preferably ensures that the door leaf can be wound on, even with radii of curvature less than 10 cm, without the coating breaking or tearing. The desired elasticity at low temperatures enables the use of the quick-action door for the closure of deep-freeze storage rooms.

In accordance with a further preferred form of embodiment, the vapor diffusion-proof coating is UV-stable. This can be ensured by an additional surface coating, or, in the case of a single-layer coating, by a suitable coating material. The coating is considered to be UV-stable if, when exposed to daylight and direct sunlight, it has a service life that is customary for quick-action doors of this type. This is preferably at least five years, and furthermore, is preferably more than ten years. Particularly preferably, the UV-stability also ensures a colour stability of the coating material, so that the visual properties of the door leaf remain essentially unchanged over its service life, even when it is exposed to sunlight.

In accordance with a further possible configuration of the invention, the vapor diffusion-proof coating is bonded to the felt material, and/or is cast, or fused, onto the felt material. The coating material can, for example, be applied in liquid or paste form to the surface of the felt material, and, if necessary, pressed against the latter before it then assumes its final strength. This can take place as a result of cooling or chemical hardening. Alternatively or additionally, the coating material can be solvent-based. The application can, for example, be carried out by way of calender rollers. However, it would also be conceivable to form the coating in the manner of a film, and then to bond it onto the felt material, for example by heating, or with the aid of an adhesive that is introduced between the film and the felt material. In this way, the felt material can be provided with a vapor diffusion-proof coating on one or both surfaces.

The side edges of the felt material are, furthermore, preferably sealed, and preferably with a plastic material. If both surfaces of the felt material are provided with a coating, the side edges of the felt material remain free; these can then be closed off with a sealant. However, even if only one surface of the felt material is provided with the coating, it can be expedient additionally to seal the side edges. The sealing process preferably takes place with a material that corresponds to the material of the coating, or has similar chemical properties. Particularly preferably, a liquid sealant material is used, which can be drawn into the structure of the felt material from the side edge, and hardens within the structure, thereby sealing the side edge. A liquid plastic, such as a liquid silicone, could be used for this purpose. Furthermore, the sealant for the side edges is also preferably formed from a material that is vapor diffusion-proof. However, since the side edges are located in the region of a door frame, they are less exposed to large temperature differences, so that in some individual cases condensation of moisture is less likely in these regions, so that in these individual cases the edge sealant can be less diffusion-proof than the coating of the surfaces.

In a particular form of embodiment of the invention, the door leaf can have at least two mutually connected layers of felt material, which are preferably bonded together. On the one hand, the formation of a plurality of layers of felt material makes it possible to combine different felt materials. On the other hand, it also makes it possible to design door leaves with varying thicknesses, as is described further below, for example. Furthermore, in this manner it is possible to produce door leaves with a greater thickness. For example, two layers of felt, each 10 mm thick, can be joined together, in particular bonded together, to form a door leaf that is 20 mm thick. It is also possible to form a door leaf coated on two sides from felt layers that are coated on one side; here two felt layers, each provided with a coating on one surface, such as the vapor diffusion-proof coating, are joined together, in particular bonded together, on their non-coated surfaces. Alternatively, or in addition to bonding, the different layers of felt material can also be sewn together. Insofar as the coating has been penetrated in this process, it is advantageous to cover the regions of the seams with a further layer of vapor diffusion-proof material, and in particular to bond this covering layer. In a similar manner, other production-related breakdowns in the coating can also subsequently be re-closed and re-sealed.

In a particular form of embodiment of the invention, the door leaf can be configured as a double door leaf. Such a double door leaf has two door leaf sections, which are arranged so that they extend parallel to each other, and are spaced apart in a direction transverse to their surface. In this manner, a cavity is formed between the two door leaf sections. At the lower end, the two door leaf sections are connected to each other. This is preferably done in a curved turn-around section of the door leaf sections, so that the two door leaf sections can be manufactured from one piece. An appropriate door leaf material is turned through 180 degrees in the region of the turn-around section, so that two spaced door leaf sections extending parallel to each other are created, which are connected to each other in the region of the turn-around section by a curved region that is essentially semicircular in cross-section, that is to say, the door leaf essentially forms a sling in cross-section. In a particular configuration, a sliding weight can be arranged in the region of the turn-around section; this preferably extends essentially over the entire width of the door leaf. The sliding weight weighs down the door leaf so that the door leaf sections are always kept stretched. In addition, it supports the unwinding of the door leaf, since it pulls the door leaf downwards by virtue of its weight. However, a configuration without a sliding weight is also possible. On the one hand, such a double door leaf has better insulation properties, but in addition, it also enables a very simple winding-on procedure and a pressing action against a door frame.

One of the door leaf sections is preferably connected at its upper end to the at least one rotatable shaft in order that the door leaf can be wound onto the latter. This is preferably the door leaf section that is spaced further apart from a door frame. The other door leaf section is preferably fixed at its upper end. Here the door leaf is preferably fixed in a region of the upper end of the door frame; furthermore, this is preferably in the region of the upper horizontal section of the door frame. A door leaf configured and arranged in this manner is wound on such that the first door leaf section is wound onto the shaft and the turn-around section moves upwards in the procedure. This results in the door leaf section that is fixed at the upper end being rolled off, or lifted off, from a door frame from its lower end during the winding-on procedure. That is to say, the door leaf section, starting from its lower end, moves upwards, and thereby in a horizontal direction, away from the door frame. This enables the door leaf to open easily, since there is essentially no friction to be overcome between the door leaf and the door frame. In an alternative configuration, however, it would also be possible not to fix the second door leaf section, but instead to connect it to a second shaft, such that the door leaf is opened by winding the two door leaf sections onto their respective shafts.

In accordance with another possible form of embodiment, a double door leaf can be configured such that the two door leaf sections are configured with different thicknesses. Here the door leaf sections are defined as those surfaces that in the closed state extend between the top and the bottom of the door. The advantage of the different thicknesses is that, for example, the side of the door leaf facing a cold region can be made thicker, and can thus have better insulation properties, while the second door leaf section, which faces towards a warmer region, can be made thinner so as to reduce the mass of the door leaf for the winding-on procedure. The different thicknesses of the door leaf sections can be implemented, for example, in the form of a multi-layer construction, in which the thinner door leaf section has one material layer, or layer of felt material, less than the thicker section. Thus, for example, the thicker door leaf section can be configured to have two layers, and the second layer of felt material can end in the region of the lower end of the door leaf, in particular in the region of the turn-around section, while the first layer of felt material is carried through, and also forms the second door leaf section. This can also be implemented in a corresponding manner with more than two layers. Alternatively, it is possible to form the two door leaf sections as separate door leaf sections, and to join them together in the region of the lower end, that is to say, in particular, in the region of a turn-around section, for example by sewing them together. Both door leaf sections can be provided with a vapor diffusion-proof coating on one or both surfaces, as has been described above. Here it is also possible, for example, to provide only one door leaf section with a coating on both surfaces, while the other door leaf section is provided with a coating on only one side. Also, it is not essential for both door leaf sections to have vapor diffusion-proof coatings. For example, one door leaf section could have a different type of coating on at least one surface. For example, the section of the door leaf that does not face towards a cold storage room, that is to say, is not adjacent to a cold storage room, need not necessarily have a vapor diffusion-proof coating on both sides, or, in certain circumstances, need not be coated at all.

In accordance with a further preferred form of embodiment, the quick-action door has a door frame, against which the door leaf abuts in the closed state so as to form a seal. Thus, a contact region of the door leaf comes into contact with the door frame so as to form a seal. In order to ensure the sealing contact, the door leaf can be directed in a guide, whereby the guide can be configured, for example, such that one side of the guide presses the door leaf against the door frame in the closed state. In accordance with another possible form of embodiment of the invention, the door frame and the door leaf can be configured such that the door leaf adheres to the surface of the door frame so as to implement the sealed contact. This can be achieved, for example, by means of magnetic forces. Such a configuration has the advantage that the door leaf and the door frame can be configured such that the door leaf abuts against the outer face of the door frame, and can move freely in a direction away from the door frame. This is an advantage in cold storage rooms, for example, as such a quick-action door can be opened from the inside by pushing it away from the door frame, even if the drive has failed. Damage to the door leaf is also prevented if, for example, a forklift truck is inadvertently driven against the closed door. In such a case, the door leaf can swing open away from the door frame, without having to be wound onto the shaft.

In order to implement a magnetic contact between the door leaf and the door frame, the door frame can have permanent magnets. These can be embedded in the door frame or applied to the surface of the door frame in the form of a magnetic strip. The permanent magnets are preferably arranged on the vertical sides of the door frame, and are distributed over the entire height of the door, such that a sealed contact between the door leaf and the door frame can be achieved over the entire height. In a complementary manner ferromagnetic metal elements are arranged in the door leaf in at least one contact region, such that the door leaf is held magnetically in contact with the door frame when it is closed. The contact regions of the door leaf preferably extend along the side edges of the door leaf over its entire height. The metal elements are preferably distributed over the entire height so that they can adhere to appropriately distributed magnetic elements or permanent magnets. A multiplicity of individual metal elements, for example metal plates or metal platelets, are preferably arranged in the door leaf; these can move relative to each other. In this manner, the metal elements do not impair the flexibility of the door leaf and do not hinder the winding-on procedure. Furthermore, the metal elements are preferably embedded in the felt material, or are located inside the felt material, such that the surface of the contact region is not impaired by the metal elements, and, by virtue of the flexibility of the material, a sealed contact with the door frame can be achieved in this region.

Furthermore, pockets can preferably be configured inside the felt material adjacent to at least one side edge, preferably adjacent to both vertical side edges, in which pockets the ferromagnetic metal elements are arranged. The pockets can, for example, be introduced as incisions from the side edge. Metal platelets can be inserted into these incisions from the side edge. After the insertion of the metal elements, these pockets are preferably closed on the side by a sealant or a bonding process. In this manner, the metal elements are held securely in the pockets in the interior of the felt material. The sealant is preferably the same sealant with which the entire side edge of the felt material is sealed, that is to say, as described above, it is preferably a sealant that is applied in liquid form to the side edge and can thus also run into the pocket, and can securely seal or bond the latter.

In the following the invention is described by way of example on basis of the accompanying figures. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic plan view onto a quick-action door in accordance with a first form of embodiment of the invention;

FIG. 2 is a side view of a quick-action door shown in FIG. 1;

FIG. 3 is a schematic plan view onto a quick-action door in accordance with a second form of embodiment of the invention;

FIG. 4 is a side view of the quick-action door shown in FIG. 3;

FIG. 5 is a side view of the quick-action door shown in FIG. 3 in an alternative form of the embodiment;

FIG. 6 is a schematic cross-sectional view through a door leaf in accordance with the first form of embodiment;

FIG. 7 is a schematic cross-sectional view through a door leaf in accordance with the second form of embodiment; and

FIG. 8 is a cross-sectional view parallel to the surface through the door leaf shown in FIG. 6.

### DESCRIPTION OF PREFERRED EMBODIMENTS

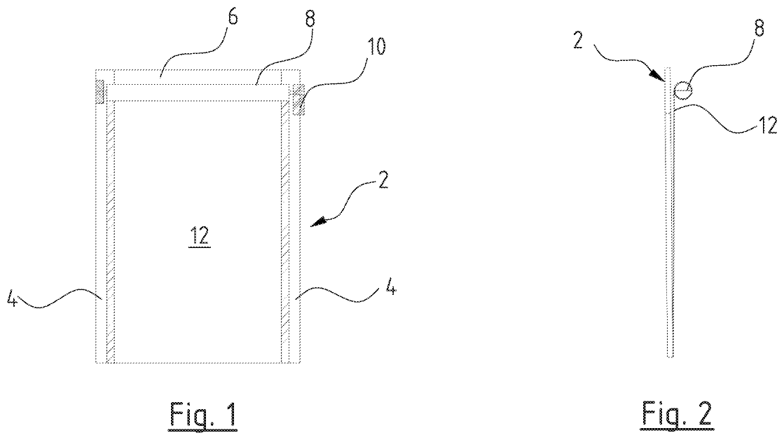

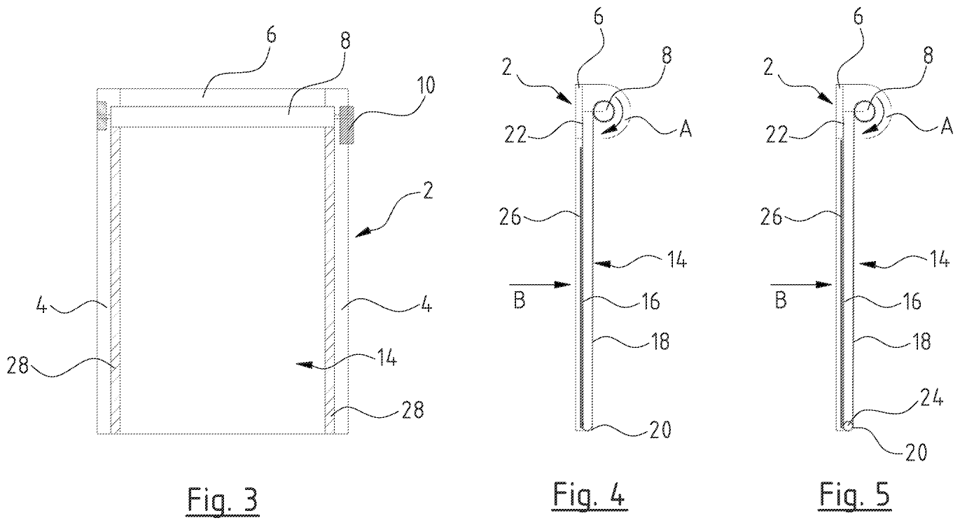

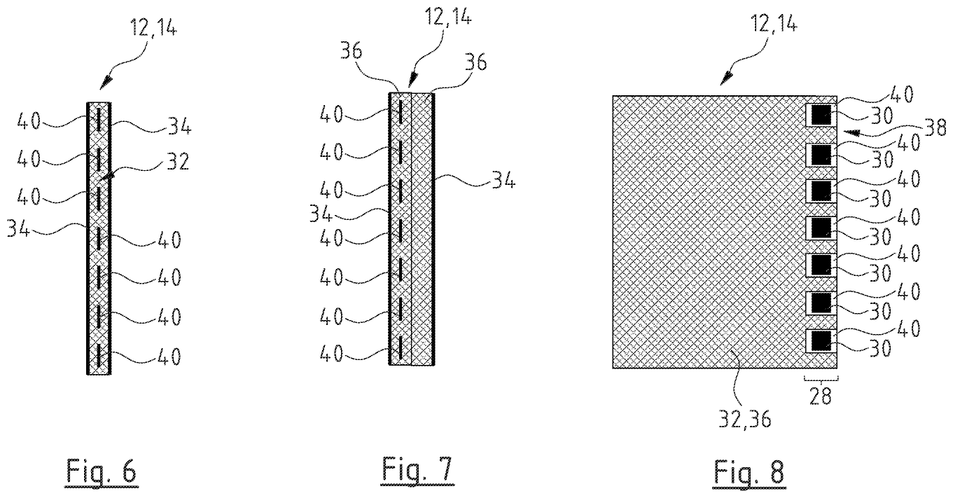

Referring to the drawings, the quick-action doors shown in FIGS. 1 and 3 have a door frame 2 formed by two lateral frame sections 4 extending essentially vertically, together with an upper frame section 6 extending horizontally. At the upper end of the door, that is to say, in the vicinity of the upper frame section 6, a rotatable shaft 8 is arranged, which extends horizontally and is driven by an electric drive motor 10. The quick-action door in accordance with FIG. 1 also has a flexible door leaf 12, which is connected to the shaft 8 at its upper end so that the door leaf 12 can be wound onto the shaft 8 by rotating the shaft 8. For this purpose, the door leaf 12 is appropriately flexible, and is made from a felt material, as described in more detail below with reference to FIGS. 6 to 8. As can be seen in the side view of FIG. 2, in the example of embodiment in FIG. 1 a simple door leaf is provided, that is to say, there is a single door leaf section that comes into contact with the door frame 2, and can be wound onto the shaft 8.

In contrast to the example of the embodiment in FIGS. 1 and 2, in the example of the embodiment in FIGS. 3 to 5 a door leaf 14 is deployed that is configured as a double door leaf. As can be seen in the side views in FIGS. 4 and 5, the door leaf 14 is formed from a door leaf web that is turned around by, or turned through, 180 degrees at the lower end, such that the sling shape that can be seen in the side view in FIGS. 4 and 5 is formed. In this manner, two door leaf sections 16 and 18 are formed in the closed state; these are connected to each other at the lower end by way of a turn-around section, that is to say, a curved region 20. The first door leaf section 16, which is closer to the door frame 2 and comes into contact with the latter, is fixed at the upper end 22 to the upper frame section 6 of the door frame 2. The upper end of the second door leaf section 18 is connected to the shaft 8, that is to say, it is wound onto the shaft 8. When the shaft 8 rotates in the direction of rotation A, the second door leaf section 18 is wound onto the shaft, and, at the same time, the first door leaf section 16 is pulled off the door frame 2 from its lower end and pulled upwards. The turn-around section 20, that is to say, the curved region 20, also moves upwards, and the door opens. To close the door, the shaft 8 is turned in the opposite direction and the door slides down again accordingly, that is to say, it falls under the force of gravity. In the example of embodiment shown in FIG. 5, there is also a sliding weight 24 in the curved region 20, which preferably extends over the entire width of the door. This sliding weight 24 weighs down the door leaf 14, pulls it down and rolls in the turn-around section 20 as the door leaf 14 is opened and closed.

In order to keep the door leaf 14 in close contact with the door frame 2, a magnetic holding device is provided in this form of embodiment. Permanent magnets in the form of magnetic strips 26 are arranged in the two lateral frame sections 4 for this purpose. These magnetic strips can also be configured as magnetic strips on the surface of the lateral frame sections 4. In addition, it would also be conceivable to embed a multiplicity of individual magnets in the lateral frame sections 4. The door leaf 14 abuts onto the surface of the lateral frame sections 4 with lateral contact regions 28, which border the lateral edges of the door leaf. Ferromagnetic metal elements in the form of metal platelets 30 are arranged in the contact regions 28 in the interior of the first door leaf section 16, as can be seen in FIG. 8. FIG. 8 shows schematically a detail of the door leaf section 16. The metal platelets 30 are attracted by the magnetic force of the magnetic strip 26, so that the door leaf section, and thus the entire door leaf 14, is held against the door frame 2. Here the door leaf 14 with the door leaf section 16 only sits on the surface of the door frame 2. This has the advantage that the door leaf can be lifted off the door frame 2 in the direction of the arrow B, if sufficient force is applied to the door leaf 14. This is a safety feature because, on the one hand, the door can be opened from the side of the door frame 2 at any time simply by applying pressure on the door leaf 14 in the direction of the arrow B. In the case of cold stores or cold storage rooms, for example, this has the advantage that the door can always thus be opened from the inside. In addition, the door can also open if a transport vehicle such as a forklift truck should accidentally drive against the door from the inside. The door leaf 14 then simply swings open in the direction of the arrow B and afterwards falls back against the door frame 2, where it is then held again in a sealed contact. As the door leaf 14 is wound onto the shaft, the metal platelets 30 at the lower end of the door leaf 14 are pulled off the door frame 2, that is to say, the lateral frame sections 4 in the horizontal direction one after another. The arrangement of a multiplicity of metal platelets 30 ensures the mobility of the door leaf 14, which is necessary for the winding-on procedure.

The configuration of the door leaves 12, 14 is described in more detail with the aid of FIGS. 6 to 8, which show schematically a detail of a door leaf 12 or 14. The door leaf is made from felt, in particular a woolen felt. In the example of embodiment shown in FIG. 6, the door leaf 12, 14 has a woolen felt layer 32, which, on its surfaces facing away from each other, is provided with a coating 34, which is vapor diffusion-proof and is fixedly bonded to the felt material. This coating 34, which is vapor diffusion-proof, can be made, for example, from polyurethane, preferably a polyether-based polyurethane, and can be bonded, or cast, or fused, directly onto the surface of the woolen felt 32. The coating 34 is flexible, such that the door leaf 12, 14 can be repeatedly rolled up and unrolled, even at very low temperatures.

In order to design a door leaf 12, 14 of greater thickness, either a thicker layer of woolen felt 32 can be used, or, as shown in the example in FIG. 7, two layers of woolen felt 36 can be joined together, for example bonded, to form a door leaf. The woolen felt layers 36 are in each case provided with a coating 34 on one surface, and the two woolen felt layers 36 are bonded together on the sides that have no coating, so that a door leaf 12, 14 is created that is provided with a coating 34 on its two outer surfaces, facing away from each other, as has been described above. If a double door leaf 14 is configured, it would be conceivable to design the door leaf section 16 from just two woolen felt layers 36, as shown in FIG. 7, while the door leaf section 18 is configured as a single layer by extending one of the woolen felt layers 36, or by joining a thinner woolen felt to the door leaf section 16 in the region of the lower end 20.

To arrange the metal platelets 30 in the interior of the woolen felt 32 or 36, pockets 40 are incised into the felt material from the side edge 38. The metal platelets 30 are inserted into these pockets 40 from the side edge, and are bonded in the pockets 40, for example by sealing the side edges 38 with a liquid plastic compound. In the case of the double door leaf 14, such pockets 40 with the metal platelets 30 are preferably only configured in the door leaf section 16. In the case of the door leaf 12, 14, which is formed from two woolen felt layers 36, the pockets 40 are preferably incised into the woolen felt layer 36, which subsequently faces the door frame 2, so that the metal platelets 30 are located closer to the door frame.

In the case of a single door, as shown in FIGS. 1 and 2, the door leaf 12 is preferably held on the door frame 2 in another manner, for example by additional pressure application elements, not shown here. In this form of embodiment the magnetic holding device, that is to say, the magnetic strips 26 and the metal platelets 30, can be dispensed with. The door leaf 12 is then, however, configured in an appropriate manner as described above, and shown in FIGS. 6 and 7, except that the pockets 40 are omitted.

While specific embodiments of the invention have been shown and described in detail to illustrate the application of the principles of the invention, it will be understood that the invention may be embodied otherwise without departing from such principles.

### LIST OF REFERENCE SYMBOLS

2 Door frame
4 Lateral frame sections
6 Upper frame section
8 Shaft
10 Drive motor
12, 14 Door leaf
16, 18 Door leaf sections
20 Curved region, turn-around section
22 Upper end
24 Sliding weight
26 Magnetic strips
28 Contact regions
30 Metal platelets
32 Woolen felt, woolen felt layer
34 Coating
36 Woolen felt, woolen felt layer
38 Side edge
40 Pockets
A Direction of rotation
B Direction of movement

What is claimed is:

1. A quick-action door comprising:
a flexible door leaf, the door leaf being comprised of a felt material;
a rotatable shaft configuration for a winding-on of the door leaf; and
a vapor diffusion-proof coating on at least one surface of the felt material.

2. A quick-action door according to claim 1, wherein the door leaf has two surfaces that face away from each other, and the vapor diffusion-proof coating is provided on each of the two surfaces that face away from each other.

3. A quick-action door according to claim 1, wherein the felt material is a felt made from natural fibers and/or artificial fibers.

4. A quick-action door according to claim 1, wherein the vapor diffusion-proof coating is comprised of a plastic material.

5. A quick-action door according to claim 1, wherein the vapor diffusion-proof coating comprises a flexibility enabling the door leaf to be rolled up, even at temperatures below 0° C.

6. A quick-action door according to claim 1, wherein the vapor diffusion-proof coating is UV-stable.

7. A quick-action door according to claim 1, wherein the vapor diffusion-proof coating is bonded to the felt material, and/or is fused to the felt material.

8. A quick-action door according to claim 1, wherein side edges of the felt material are sealed.

9. A quick-action door according to claim 8, wherein the side edges of the felt material are sealed with a plastic material.

10. A quick-action door according to claim 1, wherein the felt material of the door leaf comprises at least two mutually joined felt material layers.

11. A quick-action door according to claim 10, wherein the at least two mutually joined felt material layers are bonded together.

12. A quick-action door according to claim 1, wherein the door leaf comprises a double door leaf with two door leaf sections extending in parallel and spaced apart from one another, and wherein the two door leaf sections are connected to one another at lower ends.

13. A quick-action door according to claim 12, wherein the connection of the two door leaf sections comprises a curved turn-around section.

14. A quick-action door according to claim 12, further comprising a door frame, wherein one of the door leaf sections is connected at an upper end to the rotatable shaft configuration, and another of the door leaf sections is fixed at an upper end relative to the door frame.

15. A quick-action door according to claim 12, wherein the rotatable shaft configuration comprises a first rotatable shaft and a second rotatable shaft and one of the door leaf sections is connected at an upper end to the first rotatable shaft, and another of the door leaf sections is connected at an upper end to the second rotatable shaft.

16. A quick-action door according to claim 12, wherein the two door leaf parts are configured to be of different thicknesses.

17. A quick-action door according to claim 1, further comprising a door frame against which, in a closed state of the quick-action door, the door leaf abuts so as to form a seal.

18. A quick-action door according to claim 17, further comprising permanent magnets arranged in or on the door frame, and ferromagnetic metal elements arranged in or on the door leaf in a contact region, such that the door leaf is configured to be magnetically held in contact with the door frame.

19. A quick-action door according to claim 18, wherein the felt material comprises an interior having pockets adjacent to at least one side edge, into which pockets the ferro-magnetic metal elements are inserted.

20. A quick-action door according to claim 19, wherein the pockets are closed towards the side edge by a sealant with the ferro-magnetic metal elements in the pockets.
